(19) United States
(12) Patent Application Publication
(10) Pub. No.: US 2010/0111626 A1
(43) Pub. Date: May 6, 2010

(54) Cushion mechanism for a positive peck feed drill

(75) Inventor: Kevin William Myhill, Lexington, SC (US)

Correspondence Address: KING & SPALDING, 1180 PEACHTREE STREET , NE, ATLANTA, GA, 30309-3521, US

(73) Assignee: Cooper Industries, Houston, TX (US)

(21) Appl. No.: 12/290,545

(22) Filed: Oct. 31, 2008

(51) Int. Cl. B23Q 5/52; B23Q 11/00; B23B 43/00

(52) U.S. Cl. 408/129; 408/241 R

(57) ABSTRACT

A cushion mechanism in a positive feed drill slows the advancement of a cutter prior to reconnecting with a machining surface during a clearing operation. The cushion mechanism may be inserted in a piston, in front of a shaft, or attached to the outside of the positive feed drill. The cushion mechanism may include a spring washer, a compression spring, or a hydraulic or pneumatic damper. The cushion mechanism provides a safer and more efficient operation for positive peck drilling.

### TECHNICAL FIELD

The invention relates generally to the operation of a positive feed drill and, more particularly, to the addition of a mechanism that creates a more efficient and cleaner pecking operation.

### BACKGROUND

A positive feed drill uses a screw thread to advance a spindle to supply the feed required for drilling, reaming, and other machining operations. During the operation, chips of a material being drilled are created from the cutting action from the removal of the material. The addition of “pecking” allows chips of the material created in the machining process to be broken up into smaller pieces to be evacuated and, thus, improves the quality of the hole in the material. This pecking is conventionally performed by the quick retraction and reinsertion of the positive feed drill cutter (e.g., a drill bit) out of and back into the hole. Typically, a motor drives a spindle in rotation through a gear train. Another gear drives rotation, but also allows the spindle to feed linearly either under positive feed through several gears or through an air feed via a piston in a cylinder. The air feed is used to rapidly retract the spindle, allowing the chips to be evacuated. The spindle is then fast advanced back into the hole in the material.

When fast advancing the cutter back to the material, it is important that the cutter does not contact the machining surface at a fast rate under the air feed. If fast contact occurs, the force caused by the contact can damage the cutter. Conventional technologies attempt to set back the relative position of the cutter by stopping the spin of the gear on the spindle, which in turn reduces the capabilities and efficiency of the drilling process. Accordingly, there exists a need in the art for an improved means for rapidly inserting the rapid drill feed without causing damaging contact against the cutter, while also remaining at a constant drilling pressure.

### SUMMARY

The present invention can add a “cushion” to the end of the fast feed, thus giving a controlled feed of the cutter before the positive feed mechanism takes over for machining the material. This cushion can be achieved through the use, for example, of a spring washer, compression spring, or a pneumatic or hydraulic damper.

These and other aspects, features, and embodiments of the invention will become apparent to a person of ordinary skill in the art upon consideration of the following detailed description of exemplary embodiments showing the best mode for carrying out the invention as presently perceived.

### BRIEF DESCRIPTION OF THE DRAWING

For a more complete understanding of the present invention and the advantages thereof, reference is now made to the following description, in conjunction with the accompanying figures briefly described as follows.

FIG. 1 is a side view of a conventional positive peck feed drill.

FIG. 2 illustrates a graphical representation of the lateral position change of a conventional positive peck feed cutter during a machining cycle.

FIG. 3 illustrates a graphical representation of a lateral position change of a positive peck feed cutter employing a cushion mechanism according to an exemplary embodiment of the invention.

FIGS. 4a and 4b are a side and a partially exploded view, respectively, of a positive peck feed drill fitted with a cushion mechanism according to an exemplary embodiment of the invention.

FIGS. 5a and 5b are a side and a partially exploded view, respectively, of a positive peck feed drill fitted with an alternative cushion mechanism according to an exemplary embodiment of the invention.

FIG. 6 is a side view of a peck positive feed drill fitted with another alternative cushion mechanism according to an exemplary embodiment of this invention.

### DETAILED DESCRIPTION OF THE EXEMPLARY EMBODIMENTS

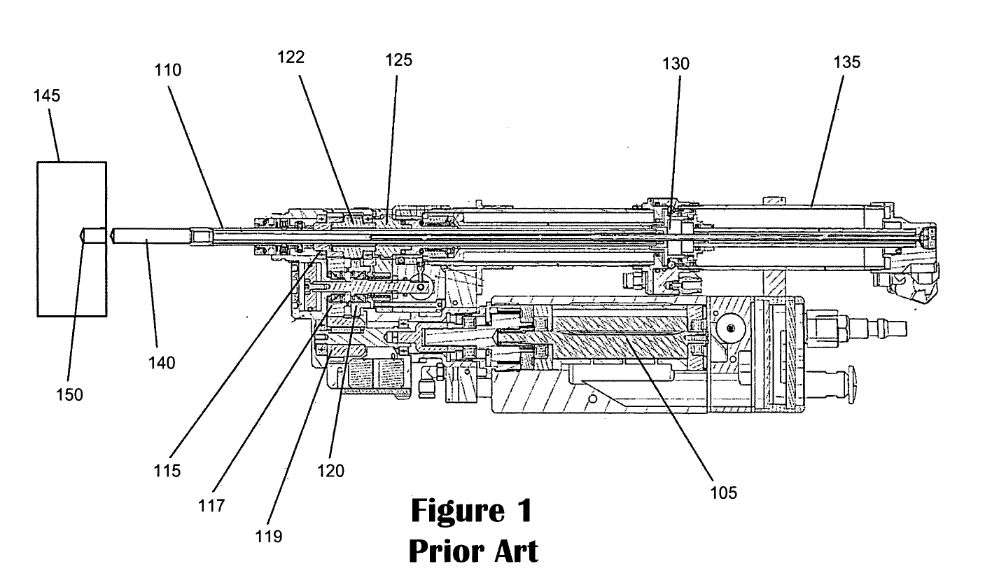

A cushion mechanism for a positive peck feed drill may include one of several different configurations to allow a positive feed drill to be rapidly retracted and advanced without damaging the cutter by forceful contact with a machining surface. FIG. 1 illustrates a conventional positive peck feed drill. In this illustration, the drill bit support mechanism and tool mounting are omitted.

As illustrated in FIG. 1, a motor 105 drives a spindle 110 in rotation through a gear train 117, 119, and 115. The gear 115 drives rotation, but also allows the spindle 110 to feed linearly either under positive feed through gears 120, 122 and 125 or through air feed via piston 130 in cylinder 135. The air feed is used to rapid retract the spindle allowing chips (not illustrated) of a material 145 accumulated at a machining surface 150 to be evacuated. After the rapid retract and evacuation operation is complete, spindle 110 is then fast advanced back towards the machining surface 150 and gear 125 engages on the face with gear 122 providing the positive feed. Piston 130 is mechanically locked in position to ensure that the cutter 140 is fed into the material 145.

When fast advancing back to the material 145, it is important that the cutter 140 doing the machining does not contact the machining surface 150 in material 145 at a fast rate under the air feed. If fast contact with the machining surface 150 occurs, the force caused by the contact can damage the cutter 140. Conventional technologies attempt to set back the position of the spindle by stopping the spin of the gear 125 on the spindle 110, which in turn, reduces the capabilities and efficiency of the drilling process. However, the cushion mechanism of the present invention provides an impedance to the forward advance of the cutter 140 just prior to the cutter 140 re-contacting the machining surface 150.

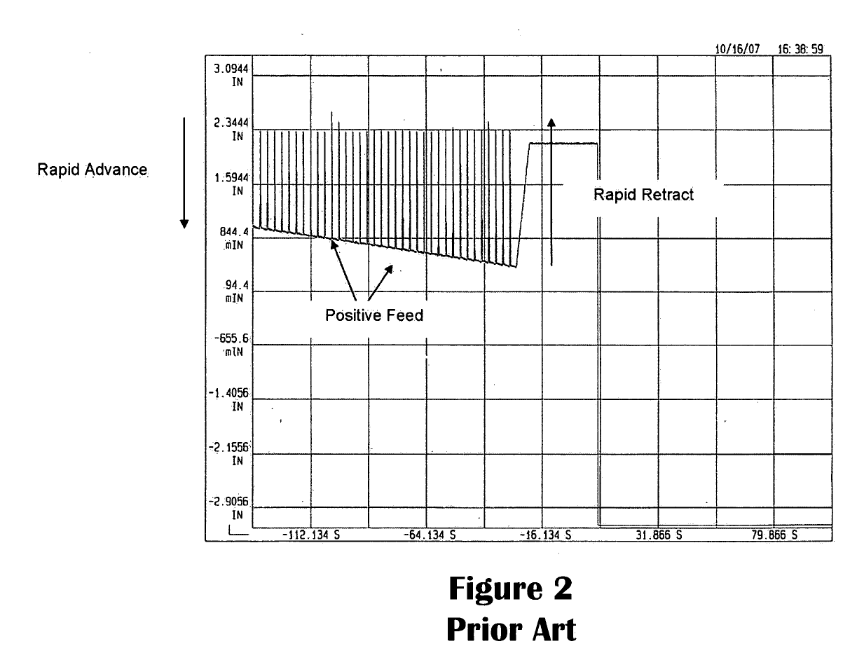

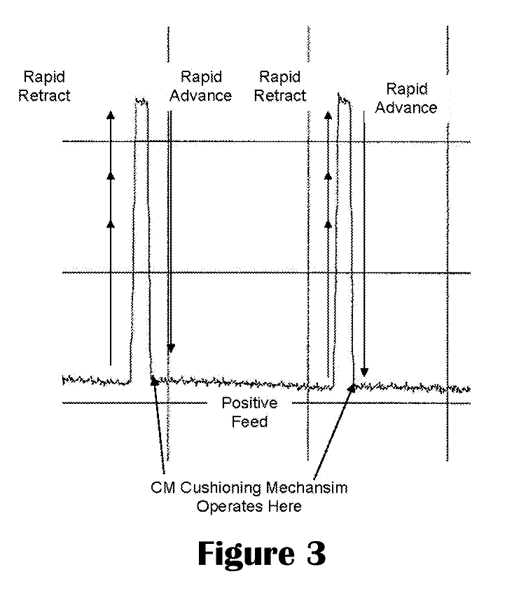

FIGS. 2 and 3 illustrate the benefits of the cushion mechanism of the present invention. In FIG. 2, the y axis represents distance, and the x axis represents time. In a conventional positive feed drill, a cutter 140 is rapidly retracted and advanced without regard for the force exerted between the cutter 140 and the machining surface 150. This situation is illustrated in FIG. 2. Because of the forceful contact, conventional positive feed drills frequently damages the cutter 140.

In FIG. 3, a graphical illustration is presented showing a positive feed drill fitted with the cushion mechanism of the present invention. As illustrated, the rapid advance is slowed as represented by reference number 305 just before the cutter 140 reaches the machine surface 150 with the feed controlled through the cushioning mechanism. Specifically, as the cutter 140 gets closer to the machining surface 150 at 305, the cushion mechanism of the present invention slows the insertion of the cutter 140 so that it does not forcefully contact the machining surface 150. In this manner, the cushion mechanism described herein prevents the cutter 140 from being damaged by the machining surface 150. Accordingly, the cushion mechanism allows for smoother contact by the cutter 140 with the machining surface 150, and does so without lengthening the positive feed drilling time, as occurs with conventional positive peck feed drill systems.

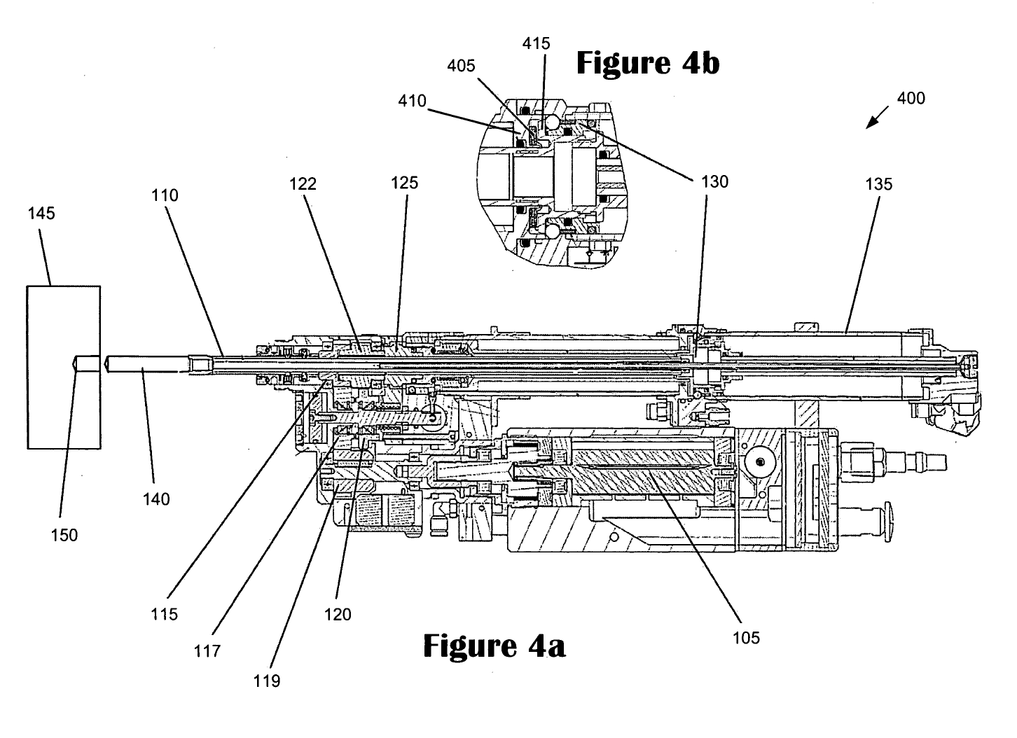

FIGS. 4a and 4b illustrate a positive peck feed drill 400 equipped with a cushion mechanism according to an exemplary embodiment of the present invention. As illustrated in FIG. 4b, one or more spring washers 405 are inserted in the piston 130 to create the cushion mechanism. An exemplary embodiment of a spring washer 405 may comprise one or more Belleville washers. When the front surface 415 of the piston 130 is retracted, the spring washer 405, which can be positioned between the piston 130 and a shaft 410, expands to a decompressed state. In turn, when the piston 130 is advanced to re-feed the cutter 140, the piston 130 contacts the spring washer 405, causing advancement of the piston 130 and, ultimately, the cutter 140, to slow. As air pressure in the positive feed drill continues to advance the piston 130, the spring washer 405 compresses at a defined compression rate until the spring washer 405 is fully compressed and the cutter 140 is back into contact with the machining surface 150. Accordingly, the one or more spring washers 405 situated in the piston 130 absorbs the energy of the advancing cutter as it nears the machining surface 150, so that the cutter 140 does not re-contact the machining surface 150 with damaging force. This process typically occurs in a span of several microseconds, such that the overall pecking and machining operation is not slowed by the addition of the cushion mechanism. In an exemplary embodiment, this advancement is slowed less than one-tenth of a one second. It should be noted that the compression rate of the spring washer 405 may be customized to lengthen or shorten the dampening effects of the cushion mechanism. The compression rate required is chosen according to the force from the cylinder 135 divided by the distance over which you want the energy to be dissipated. In an exemplary embodiment, the spring washer 405 may comprise rubber, metal, or plastic. The size and material of the spring washer 405 may determine its compression rate.

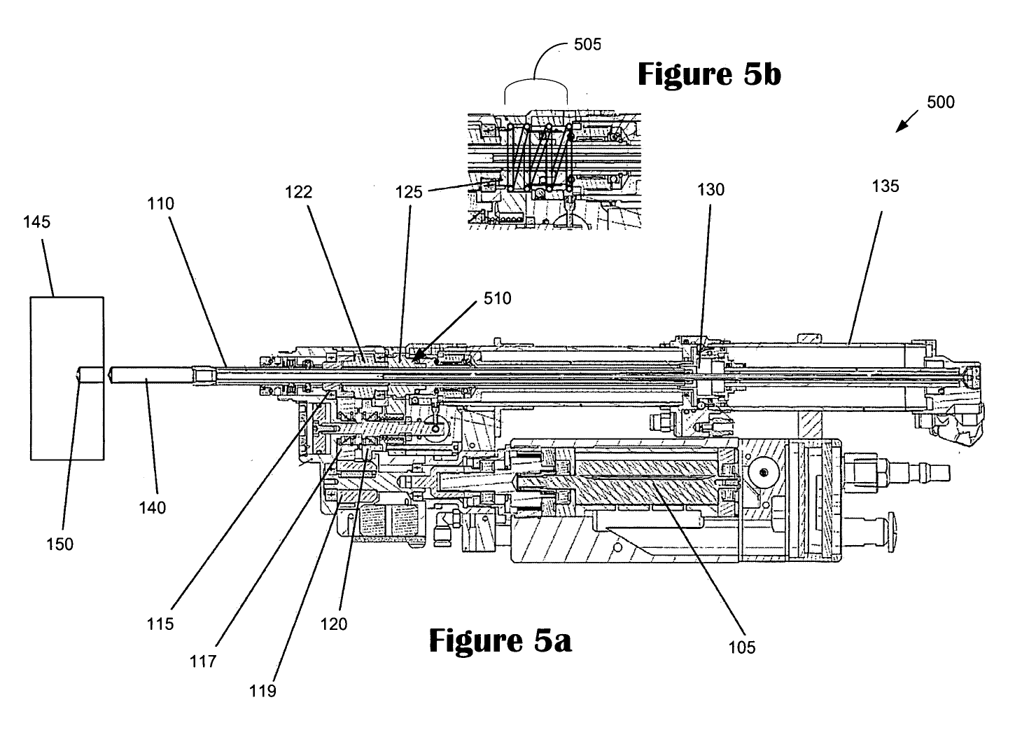

FIGS. 5a and 5b illustrate a positive feed drill 500 equipped with a cushion mechanism according to an alternative exemplary embodiment of the present invention. As illustrated in the exploded view of FIG. 5b, a compression spring 505 is inserted in the forward section of the shaft 510, in front of the gear 125, in order to impede the forward progress of the cutter 140 when the spindle 110 is advanced during a pecking operation. As with the spring washer 405 (explained with reference to FIGS. 4a-b), the compression spring 505 expands when the spindle 110 is retracted and provides counter force to slow down the advancement of the cutter 140 just prior to it coming back into contact with the machining surface 150. The speed reduction of the cutter 140 is achieved based on the placement of the compression spring 505, which is situated so that the piston 130 must engage the compression spring 505 before re-engaging the axial gear 125.

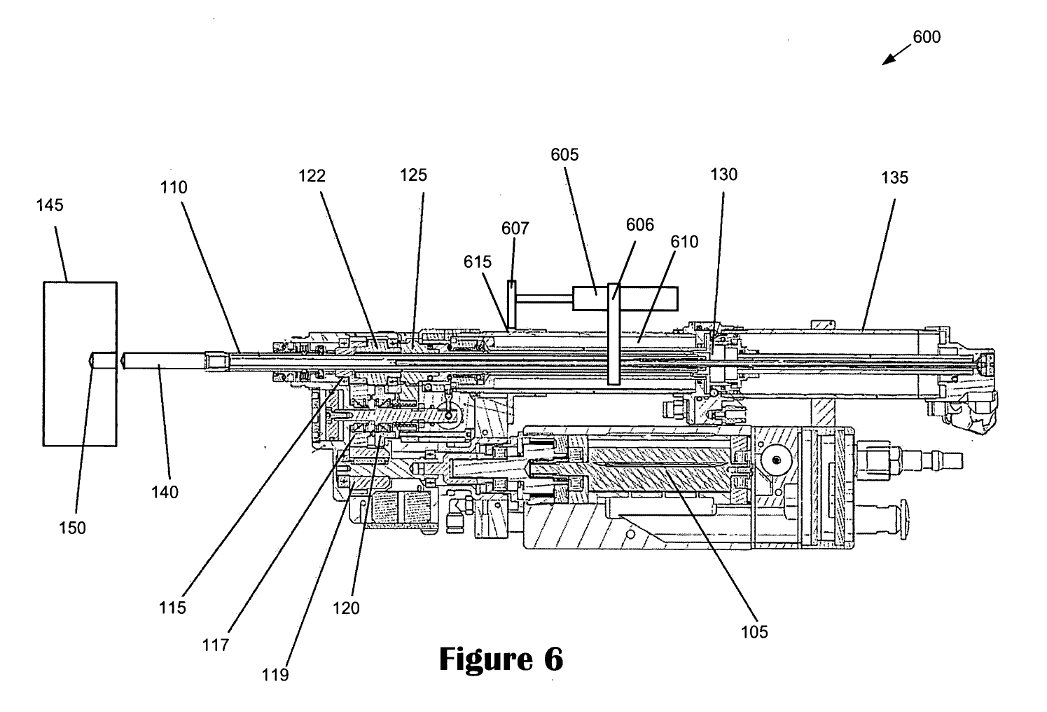

FIG. 6 illustrates yet another positive feed drill 600 equipped with a cushion mechanism according to another alternative exemplary embodiment of the present invention. As illustrated in FIG. 6, a hydraulic damper 605 slows the advance of the cutter 140 during a pecking operation. A rear holder 606 of the hydraulic damper 605 is coupled to the outside of the axial-moving shaft 610, while a forward holder 615 is coupled to a static location 615 on the drill 600. When the shaft 610 moves backwards during the chip clearing operation, the hydraulic damper 605 will expand. Then, when the shaft 610 moves forward to re-feed the cutter 140 into the machining surface, the hydraulic damper 605 impedes the advancement of the drill shaft 610 (and hence the cutter 140) just prior to contact with the machining surface 150. Alternatively to the hydraulic damper 605 illustrated in FIG. 6, the hydraulic damper 605 may also be configured inside the piston 130 to provide the same benefit as the one shown in FIG. 6. Further, the hydraulic damper 605 can be replaced with a pneumatic damper (not illustrated).

As with the other embodiments illustrated above, the hydraulic damper 605 allows the positive peck feed drill to more efficiently and safely resume cutting operation with the machine surface 150, while reducing the tendency for the cutter 140 to be damaged during the pecking operation.

Although specific embodiments of the invention have been described above in detail, the description is merely for purposes of illustration. It should be appreciated, therefore, that many aspects of the invention are described above by way of example only and are not intended as required or essential elements of the invention unless explicitly stated otherwise. Various modifications of the disclosed aspects of the exemplary embodiments, in addition to those described above, can be made by a person of ordinary skill in the art, having the benefit of this disclosure, without departing from the spirit and scope of the invention defined in the following claims, the scope of which is to be accorded the broadest interpretation so as to encompass such modifications and equivalent structures.

What is claimed is:

1. A cushion mechanism for a positive feed drill, comprising:
a spring washer inserted or coupled to a piston, wherein the washer slows the forward advancement of a piston during a pecking operation, wherein the spring washer is configured in the positive feed drill between a shaft and the piston.

2. The cushion mechanism of claim 1, wherein the cushion mechanism does not reduce a spin rate for a spindle in the positive feed drill during the pecking operation.

3. The cushion mechanism of claim 1 further comprising a cutter coupled to the positive feed drill, wherein the advancement of the piston is slowed thereby reducing the force between the cutter and a machining surface.

4. The cushion mechanism of claim 3, wherein the advancement is slowed for less than one-tenth of one second.

5. The cushion mechanism of claim 3, wherein the spring washer comprises a defined compression rate.

6. The cushion mechanism of claim 5, wherein the compression rate of the spring washer is variable and wherein the compression rate is configured to be varied to lessen the dampening effects of the cushion mechanism.

7. The cushion mechanism of claim 1, wherein the spring washer is made from one of metal, plastic, and rubber.

8. A cushion mechanism for a positive feed drill, comprising:
a motor rotationally driving a spindle;
at least one positive feed gear configured to laterally drive the spindle;
a piston at least partially disposed in a cylinder;
a compression spring adapted to slow the advancement of the piston during a pecking operation.

9. The cushion mechanism of claim 8, wherein the cushion mechanism does not reduce a spin rate for a spindle in the positive feed drill during the pecking operation.

10. The cushion mechanism of claim 8 further comprising a cutter coupled to the positive feed drill, wherein the advancement of the piston is slowed thereby reducing the force between the cutter and a machining surface.

11. The cushion mechanism of claim 8, wherein the advancement is slowed for less than one-tenth of one second.

12. The cushion mechanism of claim 8, wherein the spring washer comprises a defined compression rate.

13. The cushion mechanism of claim 12, wherein the compression rate of the spring washer is variable and wherein the compression rate is configured to be varied to lessen the dampening effects of the cushion mechanism.

14. A cushion mechanism for a positive feed drill, comprising:
a motor rotationally driving a spindle;
at least one positive feed gear configured to laterally drive the spindle;
a cylinder;
a piston comprising a first end at least partially disposed in the cylinder and a second end functionally engaged to the spindle and configured to laterally adjust the spindle; and
a hydraulic damper adapted to slow the advancement of a piston during a pecking operation.

15. The cushion mechanism of claim 14, wherein the hydraulic damper is fixed to the outside of the positive feed drill.

16. The cushion mechanism of claim 14, wherein the hydraulic damper is configured on the inside of the cylinder of the positive feed drill.

17. The cushion mechanism of claim 14, wherein the cushion mechanism does not reduce a spin rate for a spindle of the positive feed drill during the forward advancement of a pecking operation.

18. The cushion mechanism of claim 14, wherein the advancement of the piston is slowed thereby reducing the force between a cutter and a machining surface.

19. The cushion mechanism of claim 14, wherein the advancement is slowed for less than one-tenth of a second.

20. The cushion mechanism of claim 14, wherein the hydraulic damper has a defined compression rate that may be varied to lessen the dampening effects of the cushion mechanism.

21. The cushion mechanism of claim 18, wherein the cutter comprises a metal cutting drill bit.

22. The cushion mechanism of claim 18, wherein the cutter is coupled to the piston through at least one gear.

23. A positive feed drill, comprising:
a motor rotationally driving a spindle;
at least one positive feed gear configured to laterally drive the spindle;
a cylinder;
a piston comprising a first end at least partially disposed in the cylinder and a second end functionally engaged to the spindle and configured to laterally adjust the spindle; and
a cushion mechanism adapted to slow the forward advancement of a piston during a pecking operation.

24. The positive feed drill of claim 23, wherein the cushion mechanism comprises a spring washer.

25. The positive feed drill of claim 23, wherein the cushion mechanism comprises a compression spring.

26. The positive feed drill of claim 23, wherein the cushion mechanism comprises one of a hydraulic and pneumatic damper.
